(19) United States
(12) Patent Application Publication
(10) Pub. No.: US 2026/0090567 A1
(43) Pub. Date: Apr. 2, 2026

(54) All-Natural, Gluten-Free Frozen Almond Snack

(71) Applicant: Chevere Brands, LLC, Miami, FL (US)

(72) Inventors: Rafael Martinez, Panama Oeste (PA); Hilan Matos, Panama City (PA)

(21) Appl. No.: 18/903,226

(22) Filed: Oct. 1, 2024

(51) Int. Cl. A23G 9/42; A23G 9/32; A23G 9/40

(52) U.S. Cl. CPC A23G 9/42; A23G 9/322; A23G 9/40

(57) ABSTRACT

An all-natural, gluten-free frozen almond food snack comprising an almond-containing outer layer, a filling composition comprising a blend of cheeses, chocolate, caramel, fruits, fruit jellies, vegetables, and combinations thereof, and a coating containing sesame seed, chia seed, grated coconut, finely ground nuts, and blends thereof. The frozen almond snack is a nutritious, keto-friendly, low-carbohydrate, and rich in fiber, formulated to prevent a rise of the glucose curve, promotes intestinal health, nourishes microbiota in the stomach, supports intestinal transit, and lowers the glycemic index of an individual who consumes said frozen almond product and which has a superior taste.

### FIELD OF INVENTION

An all-natural, gluten-free, high fiber, low carbohydrate frozen healthy food product which prevents the rise of a glucose curve, is low in cholesterol, contributes and promotes intestinal health, nourish microbiota, lowers the glycemic index of the food, support intestinal transit and provide satiety. More particularly, the food composition comprises an almond-containing outer layer, an inner filling which is prepared from cheeses, chocolate, caramel, fruits, vegetables, and combinations thereof. The almond-containing food composition contains natural sweeteners and is a rich source of natural fats derived from almonds without any added vegetable oils.

### BACKGROUND OF THE INVENTION

The availability of frozen, ready-to-eat food snacks is lacking in the frozen sections of supermarkets. Frozen snacks that are available typically are made with high sugar content and have a processed taste. Rarely are such frozen snacks non-gluten, low in carbohydrates, keto-friendly, rich in fiber, have high nutritional value, prevent a rise of the glucose curve, and have a palatable taste. Rather, when nutritional value products are available in the frozen section of a supermarket, the products usually are presented as complete meals. Rarely can a consumer find a healthy snack option which is not in the form of a bar, and very rarely can the consumer find a healthy snack option having a superior taste which satisfies the palate.

### PRIOR ART

The prior art is replete with compositions and processes for producing snack products including snacks containing chocolate, cheeses, and/or almonds. U.S. Pat. No. 7,592,030 B2 to Jarrett discloses a food product having almonds and/or cashews which have been finely ground, a liquefying agent (typically water or milk), capable of forming a cream when combined with the ground nuts, a sweetening agent (typically cane sugar), and salt. A flavoring agent, including chocolate or raw ground fresh fruit, may be added to the mixture. Jarrett contemplates that the resulting mixture can be frozen and later consumed as a product which mimics the texture, flavor and consistency of frozen yoghurt and other ice cream substitutes. A significant drawback to Jarrett is that it does not use all-natural ingredients, and particularly uses sugar. Further, the Jarrett food product is not a snack bite, nor does it have a filled center.

U.S. Patent Application Publication 2015/0132455 A1 to Anghasekvilai relates to a confectionary snack having chewing fruit casing with a center filling having fruit jam and sugar. Like Jarrett, Anghasekvilai does not use all-natural ingredients and uses sugar. Further, Anghasekvilai does not teach the use of a fibrous component or nut component. In U.S. Patent Application Publication 2004-0013776 A1 to Whitehouse et al, a filled confectionary product is disclosed having a fat-containing confectionary shell, primarily derived from chocolate, and a viscous confectionary filling which is derived from sugar. Whitehouse et al. teaches the use of sugar in a confectionary product, which like Jarrett and Anghasekvilai, are not contemplated to be healthy snack products.

Numerous international patent references teach the use of chocolate, almonds, and cheeses in a variety of food products, including food products with fillings, and are considered representative of the state of the art: KR100343541 B1 to Lotte Confectionery Co. Ltd, EP0890316A2 to Faust, DE202006002608 U1 to Zisser, ES2152901B1 to Sanchez, ES2151863B1 to Felez Rosello, CN107772357A to Meng, CN109864105 to Yupei, and JP3655967B2 to Matsumoto et al. None of these references teach an all-natural, gluten free frozen almond food product.

### SUMMARY OF THE INVENTION

The invention of the present subject matter relates to a frozen food product which is a nutritious, keto-friendly, low-carbohydrate, and high fiber frozen food product which prevents the rise of the glucose curve and has a highly palatable taste.

Accordingly, it is an object of the present subject matter to provide a ready-to-eat snack with a high nutritional value.

It is another object of the present subject matter to provide an all-natural, gluten-free frozen almond bite snack product that prevents a rise in the glucose level.

It is still another object of the present subject matter to provide an all-natural, gluten-free frozen almond bite snack that is keto-friendly.

It is yet another object of the present subject matter to provide an all-natural, gluten-free frozen almond bite snack that has a superior taste.

It is a further object of the present subject matter to provide an all-natural, gluten-free frozen almond bite snack that is low in carbohydrates, rich in fiber content, and composed only of natural sweeteners.

It is yet a further object of the present subject matter to provide an all-natural, gluten-free frozen almond bite snack that is stuffed with a blend of a semi-soft white cheese, mozzarella, and chocolate, resulting in a foodstuff having 2.0-gram net carbs per 25.0-gram unit.

It is still a further object of the present subject matter to provide an all-natural, gluten-free frozen almond bite snack that is convenient to prepare, either by use of an air fryer or by simple thawing.

It is an additional object of the present subject matter to provide a frozen almond bite snack option for individuals who have diabetes or celiac disease.

It is an additional object of the present invention to provide an all-natural, gluten-free frozen almond bite snack that is high in fiber content such that it contributes to and promotes intestinal health, nourish microbiota, and lowers the glycemic index of the food.

It is another object of the present invention to provide an all-natural, gluten-free frozen almond bite snack that provides a healthy energy booster alternative prior to the participation in exercise of sporting activities.

These and other objects of the present subject matter are accomplished by providing an all-natural, glute-free product comprising an outer almond-containing layer, a filling composed of a cheese blend, chocolate, caramel, fruits and fruit jellies, vegetables, and combinations thereof, and a coating of seeds, grated coconut, finely ground nuts, and blends thereof.

### DETAILED DESCRIPTION OF THE INVENTION

In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

The terms “almond bite”, “almond-containing food product”, “frozen snack”, “frozen food product”, “frozen almond bite”, derivatives, and similar terms may be used throughout the specification and it is to be understood that such terms are interchangeable and all refer to the all-natural, gluten-free frozen almond snack of the present subject matter.

In the following description the phraseology and terminology used herein is for the purpose of description and should not be regarded as limiting. The use of the terms “including”, “comprising”, “having”, and variations thereof herein is meant to encompass the items listed thereafter and equivalents thereof as well as additional items.

The present subject matter is directed to an all-natural, gluten-free frozen almond snack product, sometimes referred to as an almond bite or frozen almond bite. The unique composition results in a food product having a low carbohydrate content, rich in fiber, high in protein and low in cholesterol. The frozen almond bite is formulated to prevent a rise of the glucose curve, and the fibrous component contributes and promotes intestinal health, nourishes microbiota in the stomach, supports intestinal transit, and lowers the glycemic index of the food product. Further, this unique formulation provides satiety with a superior palatable taste.

The frozen almond bite of the present subject matter comprises an almond-containing outer layer, a filling composed of a blend of cheeses, chocolate, caramel, fruits, fruit jellies, vegetables, and combinations thereof, and a fine coating containing sesame seed, chia seed, poppy seeds, grated coconut, finely ground nuts, such as finely ground walnuts, and blends thereof.

More particularly, the outer layer of the frozen almond bite is produced as a dough-like composition comprising from about 40% by weight to about 80% by weight of raw whole almonds or a mixture of raw whole almonds and raw whole nuts, from about 1.0% by weight to about 10.0% by weight of one or more natural sweeteners selected from the group consisting of erythritol, allulose, monk fruit, stevia, and blends thereof, from about 0.5% by weight to about 5% by weight of an egg component selected from the group consisting of dried eggs, egg yolk and egg whites, from about 0.5% by weight to about 5.0% by weight of fibrous component selected from the group consisting of psyllium husk, soluble tapioca fiber, powdered polydextrose, and inulin powder, from about 0.5% by weight to about 5% by weight of a thickening agent selected from the group consisting of xanthan gum and guar gum, from about 0% by weight to about 5% by weight of salt, and from about 10% by weight to about 40% by weight by water. It will be understood, particularly by those skilled in the art, that the fibrous component contributes to and promotes intestinal health, nourish microbiota, and lowers the glycemic index of the food.

In a preferred embodiment, the dough-like composition comprises a blend of from about from about 60.0% by weight to about 75.0% by weight of ground almonds or of a mixture of ground whole nuts and ground whole almonds, from about from about 15.0% by weight to about 25.0% by weight water, from about 3.0% by weight to about 6.0% by weight of one of more natural sweeteners such as erythritol, allulose, monk fruit and stevia, from about 1.5% by weight to about 3.0% by weight of an egg component such as dried eggs, egg yolk, egg whites, and blends thereof, from about 0.5% by weight to about 2.0% by weight of a fibrous component selected from the group consisting of psyllium husk, soluble tapioca fiber, powdered dextrose, and inulin powder, from about 0.5% by weight to about 1.0% by weight of a thickening agent, such as xanthan gum, guar gum and mixtures thereof, and from about 0.05% by weight to about 1.0% by weight salt.

In an alternate embodiment, the natural sweetener component may further comprise honey, maple syrup, and sugar alcohols.

The frozen almond bite of the present invention further comprises a filling component which can be a blend of cheeses including semi-soft white cheese, white cheese, mozzarella cheese, cheddar cheese, and vegan cheese, chocolate and dark chocolate, caramel, fruits, fruit jellies, vegetables such as broccoli, spinach, and cauliflower, and combinations thereof. After the almond-containing outer layer is filled, the resulting frozen almond bite is finished with a natural fine coating, including sesame seed, chia seed, poppy seeds, grated coconut, finely ground nuts, such as finely ground walnuts, and blends thereof.

The manufacture of the frozen almond bite of the present subject matter comprises the steps of (1) grinding the blend of raw almonds or blends of almonds and other whole nuts to form a nut meal, (2) mixing the nut meal with the natural sweetener, egg component, fibrous component, thickening agent, optionally salt, and water to form a dough composition, (3) preparing the filling composition, (4) combining and processing the dough composition and filling composition to form an almond-containing outer layer of the dough composition and a center of the filling composition, (5) shaping the resulting formation into a plurality of rounded-like food products, (6) breading the outer layer of each of the plurality of the rounded-like food products with the fine coating containing sesame seed, chia seed, grated coconut, finely ground nuts, and blends thereof, and (7) chilling each of the resulting breaded food products to a temperature of below about 0° F. (or about −18° C.). Each of the plurality of frozen foods products are then packaged. Each unit of the resulting almond food snacks contains from about 2.0-gram to about 2.5-gram net carbs per unit.

It should be apparent that the almond-containing outer layer does not undergo any baking or other cooking process. However, depending upon the desired filling composition, the filling composition may be pasteurized or pre-cooked. For example, the chocolate filling may be produced by the mixing of ingredients at a hot temperature and allowing the mixture to cool. The various cheeses are prepared from pasteurized milk. Vegetables may be blanched in boiling water. And the fruits and fruit jellies may be blanched in boiling water as well as being fully cooked.

The grinding of the raw whole almonds or whole almonds and nuts blend can be performed with any suitable equipment as will be obvious to those skilled in the art. For instance, the whole almonds and nuts may be processed in an industrial grinder and the mixing operation to form both the dough composition and filler composition may be executed using an industrial mixer. A forming and encrusting machine may be used to extrude the almond-containing outer layer and inner filling prior to shaping into rounded-like food products.

In a first preferred embodiment, the outer almond-containing layer of the frozen almond snack of the present subject matter comprises whole almonds, erythritol, dried eggs, psyllium husk, xanthan gum, salt, and water.

Almond Dough Formulation

| Ingredient | %/weight |
|---|---|
| Whole raw almonds | 60.0-75.0 |
| Erythritol | 3.6-6.0 |
| Dried eggs | 1.5-3.0 |
| Psyllium husk | 0.5-2.0 |
| Xanthan gum | 0.5-1.0 |
| Salt | 0.25-1.0 |
| Water | 15.0-25.0 |

In the following examples, frozen almond snacks are prepared with selected filling compositions and are considered to be merely illustrative of the many possible fillings for use in the present invention.

Example 1 describes a cheese-filled almond bite.

Almond Bites with a blend of white cheese and mozzarella

| Ingredient | %/weight |
|---|---|
| Almond Dough Formulation | 60.0-70.0 |
| Pasteurized white cheese | 15.0-20.0 |
| Mozzarella cheese | 5.0-10.0 |
| Sesame seed coating | 2.0-4.0 |

Example 2 describes a chocolate-filled almond bite with no sugar added.

Almond Bites with a blend of white cheese and mozzarella

| Ingredient | Ingredient |
|---|---|
| Almond Dough Formulation | 60.0-70.0 |
| Chocolate | 25.0-35.0 |
| Finely ground walnut Coating | 2.0-5.0 |

Example 3 describes an almond bite stuffed with cheddar cheese and broccoli.

Almond Bites with a blend of white cheese and mozzarella

| Ingredient | Ingredient |
|---|---|
| Almond Dough Formulation | 50.0-60.0 |
| Cheddar cheese | 15.0-20.0 |
| Broccoli | 10.0-15.0 |
| Sesame seed coating | 2.0-4.0 |

Example 4 describes an almond bite stuffed with a plant-based cheese.

Almond Bites with a blend of white cheese and mozzarella

| Ingredient | Ingredient |
|---|---|
| Almond Dough Formulation | 70.0-80.0 |
| Plant-based mozzarella or cheddar cheese | 20.0-35.0 |
| Sesame seed coating | 1.0-3.0 |

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, under the provisions of 35 U.S.C § 112, sixth paragraph, unless the element is expressly recited using the phrase “means for . . . ” and no method or process step herein is to be construed under those provisions unless the step, or steps, are expressly recited using the phrase “step(s) for . . . .”

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

1. An all-natural, gluten-free frozen almond food product comprising from about 50% by weight to about 80% by weight of an almond-containing outer layer, a filling composition contained within said outer layer, said filling composition comprising from about 20% by weight to about 50% by weight of a cheese selected from the group consisting of semi-soft white cheese, white cheese, mozzarella cheese, cheddar cheese, and plant-based cheeses, a vegetable selected from the group consisting of broccoli, spinach, cauliflower, and combinations thereof, chocolate, caramel, fruit, natural fruit jellies, and blends thereof, and an all-natural fine coating of said almond-containing outer layer.

2. The all-natural gluten-free frozen almond food product in accordance with claim 1, wherein said all-natural fine coating is selected from sesame seeds, chia seeds, poppy seeds, grated coconut, finely ground nuts, and blends thereof.

3. The all-natural gluten-free frozen almond food product in accordance with claim 1, wherein said almond containing outer layer comprises:
a. from about 40.0% by weight to about 80.0% by weight of at least one whole nut component selected from raw whole almonds and blends of raw whole almond with raw whole nuts;
b. from about 1.0% by weight to about 10.0% by weight of at least one natural sweetener selected from erythritol, allulose, monk fruit, and stevia;
c. from about 0.5% by weight to about 5.0% by weight of an egg component selected from the group consisting of dried eggs, egg yolk and egg whites;
d. from about 0.5% by weight to about 5.0% by weight of fibrous component selected from the group consisting of psyllium husk, soluble tapioca fiber, powdered polydextrose, and inulin powder;
e. from about 0.5% by weight to about 5.0% by weight of a thickening agent selected from the group consisting of xanthan gum and guar gum;
f. from about 0% by weight to about 5.0% by weight of salt, and
g. from about 10% by weight to about 40% by weight by water.

4. The all-natural gluten-free frozen almond food product in accordance with claim 3, wherein said all-natural fine coating is selected from sesame seeds, chia seeds, grated coconut, finely ground nuts, and blends thereof.

5. The all-natural gluten-free frozen almond food product in accordance with claim 1 having about a 2.0-gram to about a 2.5-gram net carbs per unit of said food product.

6. The all-natural, gluten-free frozen almond food product in accordance with claim 1, wherein said natural sweetener is selected from the group consisting of erythritol, allulose, monk fruit, stevia, honey, maple syrup, and sugar alcohols.

7. The all-natural gluten-free frozen almond food product in accordance with claim 1, wherein said almond containing outer layer comprises:
a. from about 60.0% by weight to about 75.0% by weight of raw whole almonds and blends of raw whole almonds and raw whole nuts;
b. from about 3.0% by weight to about 6.0% by weight of at least one natural sweetener selected from the group consisting of erythritol, allulose, monk fruit, and stevia;
c. from about 1.5% by weight to about 3.0% by weight of an egg component selected from the group consisting of dried eggs, egg yolk and egg whites;
d. from about 0.5% by weight to about 2.0% by weight of fibrous component selected from the group consisting of psyllium husk, soluble tapioca fiber, powdered polydextrose, and inulin powder;
e. from about 0.5% by weight to about 1.5% by weight of a thickening agent selected from the group consisting of xanthan gum and guar gum;
f. from about 0.25% by weight to about 1.0% by weight of salt, and
g. from about 15.0% by weight to about 25.0% by weight by water.

8. The all-natural gluten-free frozen almond food product in accordance with claim 1, wherein said almond-containing outer layer comprises from about 60.0% by weight to about 75.0% by weight of ground almonds, from about from about 15.0% by weight to about 25.0% by weight water, from about 3.0% by weight to about 6.0% by weight erythritol, from about 1.5% by weight to about 3.0% by weight dried eggs, from about 0.5% by weight to about 1.5% by weight psyllium husk, from about 0.5% by weight to about 1.5% by weight xanthan gum, and from about 0.25% by weight to about 1.0% by weight salt.

9. The all-natural gluten-free frozen almond food product in accordance with claim 8, wherein said filling composition comprises from about 20.0% by weight to about 30.0% by weight of a blend of a semi soft white cheese and a mozzarella cheese, and from about 2.0% by weight to about 4.0% by weight of a coating of sesame seeds.

10. The all-natural gluten-free frozen almond food product in accordance with claim 8, wherein said filling composition comprises from about 25.0% by weight to about 35.0% by weight of a chocolate having no added sugar, and from about 2.0% by weight to about 5.0% by weight of a coating of finely ground walnuts.

11. The all-natural gluten-free frozen almond food product in accordance with claim 8, wherein said filling composition comprises from about 25.0% by weight to about 35.0% by weight of a blend of a cheddar cheese and broccoli, and from about 2.0% by weight to about 5.0% by weight of a coating of sesame seeds.

12. The all-natural gluten-free frozen almond food product in accordance with claim 8, wherein said filling composition comprises from about 25.0% by weight to about 35.0% of a plant-based cheese, and from about 1.0% by weight to about 3.0% by weight of a coating of sesame seeds.

13. The all-natural gluten-free frozen almond food product in accordance with claim 3, wherein the process of making said almond food product comprises the steps of:
a. grinding said blend of raw whole nuts including almond nuts to form a nut meal;
b. mixing said nut meal with said at least one natural sweetener, said egg component, said fibrous component, said thickening agent, salt, and water to form a dough composition;
c. preparing said filling composition in a mixer;
d. combining and processing said dough composition and said filling composition to form an almond-containing outer layer of said dough composition and a center of said filling composition, and
e. shaping said resulting formation into a plurality of rounded-like food products having an almond-containing outer layer and a center of said filling composition.

14. The all-natural gluten-free frozen almond food product in accordance with claim 13, wherein the process of making said almond food product further comprises the steps of:
a. coating the outer layer of each of said plurality of rounded-like food products with said an all-natural fine coating to form a plurality of coated food products, and
b. chilling each of said plurality of coated food products to lower the temperature of each of said plurality of coated food products to about 0° F. (−18° C.) to form a plurality of frozen almond food products.

15. The all-natural, gluten-free frozen almond product in accordance with claim 1 which is formulated with said fibrous component to promote intestinal health, nourish microbiota in the stomach, support intestinal transit, and lower the glycemic index in an individual who consumes said frozen almond product.

16. The all-natural, gluten-free frozen almond food product in accordance with claim 1, which is formulated to prevent a rise of the glucose curve in an individual who consumes said frozen almond product.

17. An all-natural, gluten-free frozen almond food product comprising from about 50.0% by weight to about 80.0% by weight of an almond-containing outer layer composition and from about 20.0% by weight to about 50.0% by weight of a filling composition, wherein said almond-containing outer layer comprises:
a. from about 40.0% by weight to about 80.0% by weight of a blend of raw whole nuts including raw whole almonds;
b. from about 1.0% by weight to about 10.0% by weight of a blend of one or more natural sweeteners selected from the group consisting of erythritol, allulose, monk fruit, and stevia;
c. from about 0.5% by weight to about 5.0% by weight of an egg component selected from the group consisting of dried eggs, egg yolk, and egg whites;
d. from about 0.5% by weight to about 5.0% by weight of a fibrous element selected from the group consisting of psyllium husk, soluble tapioca fiber, powdered polydextrose and inulin powder;
e. from about 0.5% by weight to about 5.0% by weight of a thickening agent selected from the group consisting of xanthan gum and guar gum;
f. from about 0% by weight to about 5.0% aby weight of salt, and
g. from about 10.0% by weight to about 40.0% by weight of water;
and wherein said filling composition comprises a cheese selected from the group consisting of semi-soft white cheese, white cheese, mozzarella cheese, cheddar cheese, and vegan cheese, a vegetable selected from the group consisting of broccoli, spinach, cauliflower, and combinations thereof, chocolate, caramel, fruit, natural fruit jellies and blends thereof.

18. The all-natural, gluten-free frozen almond food product in accordance with claim 17, wherein said almond food product is formed into a plurality of rounded-like food products having said almond-containing outer layer and a center having said filling composition, and each of said plurality of rounded food products is coated with an all-natural fine coating and frozen to a temperature of about 0° F. (−18° C.).

19. The all-natural gluten-free frozen almond food product in accordance with claim 18, wherein said all-natural fine coating is selected from sesame seeds, chia seeds, poppy seeds, grated coconut, finely ground nuts, and blends thereof.
